(19) United States
(12) Patent Application Publication
(10) Pub. No.: US 2023/0407187 A1
(43) Pub. Date: Dec. 21, 2023

(54) Converting Motor Fuels Range Distillates to Light Olefins in a Multiple Riser Fluid Catalytic Cracking (FCC) Unit

(71) Applicant: KELLOGG BROWN & ROOT LLC, Houston, TX (US)

(72) Inventors: Rahul Pillai, Houston, TX (US); Rajeev Ranjan, Delhi (IN)

(73) Assignee: KELLOGG BROWN & ROOT LLC, Houston, TX (US)

(21) Appl. No.: 17/843,586

(22) Filed: Jun. 17, 2022

(51) Int. Cl. C10G 11/05; B01D 3/14

(52) U.S. Cl. CPC C10G 11/05; B01D 3/14; C10G 2300/1074; C10G 2300/107; C10G 2400/08; C10G 2400/04; C10G 2400/30; C10G 2400/20

(57) ABSTRACT

Processes and systems for fluid catalytic cracking (FCC) of hydrocarbon feeds using a multiple riser FCC reactor are described. The conditions in each riser can be tailored for handling a different feed. For example, one riser may be configured to crack heavy hydrocarbons, such as vacuum gas oil (VGO) to yield medium and light products. Other risers may be configured to crack low and/or medium hydrocarbons to yield light olefins. Embodiments of the disclosed processes and systems may be used to provide a product spectrum that has greater amounts of light olefins.

### FIELD OF THE INVENTION

This application relates to a reactor system used in a fluid catalytic cracking (FCC) system, and more particularly to methods and systems for selectively shifting the product profile from an FCC process toward more light olefin products based on the feedstock using multiple risers, each optimized based on the feedstock.

### INTRODUCTION

Fluid Catalytic Cracking (FCC) is a process typically used in refineries to improve yields for transportation fuels such as gasoline and distillates. The FCC process uses a reactor called a riser, essentially a pipe, in which a hydrocarbon feed is contacted with catalyst particles to effect the conversion of the feed to more valuable products. The FCC unit converts gas oil or resid feeds by “cracking” the hydrocarbons into smaller molecules. The resulting hydrocarbon gas and catalyst mixture both flow in the riser, hence the term fluid catalytic cracking.

As employed in today's refineries, the FCC unit can convert primarily heavy feeds (such as vacuum gas oils, reduced crudes, atmospheric tower bottoms, vacuum tower bottoms and the like), into transportation fuel products (such as gasoline, diesel, heating oils, and liquefied petroleum gases). There is a declining trend in global demand for transportation fuels such as diesel with a sustained growth in demand for petrochemicals. Demand reduction for transportation fuels can be attributed to increased motor vehicle fuel efficiency and use to alternative source of fuels such as hydrogen and chemically stored electricity (batteries and fuel cells). This lower demand for transportation fuels will result in its surplus availability in the marketplace. On the other hand, there will be growing demand for petrochemical products due to increasing population and consumer demand. Propylene is an important raw material in the production of polypropylene, acrylonitrile, propylene oxide, oxo-alcohols and a wide range of industrial products. Demand for propylene is increasing across all global regions, mainly driven by demand for polypropylene, which accounts for more than 60% of all propylene demand. The propylene market is forecast to grow by an average annual rate of 4% in the coming years.

In recent years, FCC has played an increasing role in the production of propylene as a valuable by-product. Hence it is envisaged to use FCC to upgrade surplus transportation fuels such as naphtha, kerosene, diesel and oxygenates, etc., into light olefins such as propylene and ethylene. However, co-processing diesel, kerosene, and/or naphtha along with vacuum gasoil (VGO) or resid in a conventional single riser FCC is challenging because the conditions required to crack lower boiling distillates to propylene and ethylene are quite different than what is required for VGO and/or resid. If diesel is co-processed with VGO or resid in a single riser, most of the diesel will convert into Light Cycle Oil (LCO), which has a lower quality than diesel, without producing appreciable amounts of propylene. Likewise, co-processing kerosene in a single riser with VGO or Resid tends to produce primarily gasoline and (LCO).

Accordingly, there is a need in the art to shift the product spectrum of FCC processes toward greater quantities of light olefins, such as propylene and ethylene.

### SUMMARY

Disclosed herein is a process for cracking hydrocarbons using a multiple riser fluid catalytic cracking (FCC) reactor, the method comprising: cracking a heavy hydrocarbon feed in a first riser using first FCC conditions to form a first effluent enriched in medium and/or light hydrocarbons, and cracking one or more light and/or medium hydrocarbon feeds in one or more risers different than the first riser under FCC conditions different than the first FCC conditions to form one or more effluents enriched in light olefins. According to some embodiments, the heavy feed comprises one or more hydrocarbons having an average carbon number of 18 or more. According to some embodiments, the heavy feed comprises one or more components selected from the group consisting of vacuum gas oil (VGO), reduced crudes, atmospheric tower bottoms, vacuum tower bottoms, resid, and de-asphalted oil (DAO). According to some embodiments, the first effluent is enriched in hydrocarbons having a carbon number of 3 to 18. According to some embodiments, the one or more light and/or medium hydrocarbon feeds comprise distillates. According to some embodiments, the one or more light and/or medium hydrocarbon feeds comprises one or more hydrocarbons having an average carbon number of 1 to 18. According to some embodiments, the one or more light and/or medium hydrocarbon feeds comprises one or more components selected from the group consisting of jet fuel, diesel, naphtha, kerosene, C4s, and oxygenates. According to some embodiments, the first FCC conditions comprise maintaining an outlet temperature of the first riser at 510° C. to 575° C. According to some embodiments, the first FCC conditions comprise mixing steam and the heavy hydrocarbon feed in the first riser a concentration of 1 wt. % to 6 wt %. According to some embodiments, the FCC conditions different than the first FCC conditions comprise maintaining an outlet temperature of the one or more risers different than the first riser at 550° C. to 675° C. According to some embodiments, the FCC conditions different than the first FCC conditions comprise mixing steam with the one or more light and/or medium hydrocarbon feeds at a concentration of 5 wt. % to 20 wt %. According to some embodiments, the process further comprises providing at least a portion of the first effluent to the one or more risers different than the first riser. According to some embodiments, providing at least a portion of the first effluent to the one or more risers different than the first riser comprises: using a fractionation system to fractionate the first effluent to yield a fractionated stream enriched in one or more of the components of the first effluent, and recycling the fractionated stream from the fractionation system to the one or more risers different than the first riser. According to some embodiments, the fractionated stream is enriched in one or more of naphtha and C4s. According to some embodiments, cracking one or more light and/or medium hydrocarbon feeds in one or more risers different than the first riser comprises: cracking a medium feed in a second riser under second FCC conditions, and cracking a light feed in a third riser under third FCC conditions different than the second FCC conditions. According to some embodiments, the medium feed comprises one or more of gasoline, kerosene, jet fuel, and diesel fuel. According to some embodiments, the second FCC conditions comprise maintaining an outlet temperature of the first riser at 550° C. to 675° C. According to some embodiments, the light feed comprises one or more of naphtha, C4s, and oxygenates. According to some embodiments, the FCC reactions in each of the risers comprise cracking using a catalyst mixture comprising a Y zeolite and a shape selective zeolite. According to some embodiments, the shape selective zeolite is ZSM-5.

Also disclosed herein is a fluid catalytic cracking (FCC) reactor, comprising: a first riser configured to crack a heavy hydrocarbon feed and using first FCC conditions to form a first effluent enriched in medium and/or light hydrocarbons, and one or more additional risers configured to crack one or more light and/or medium hydrocarbon feeds under FCC conditions different than the first FCC conditions to form one or more effluents enriched in light olefins. According to some embodiments, heavy feed comprises one or more hydrocarbons having an average carbon number of 18 or more. According to some embodiments, the heavy feed comprises one or more components selected from the group consisting of vacuum gas oil (VGO), reduced crudes, atmospheric tower bottoms, vacuum tower bottoms, resid, and de-asphalted oil (DAO). According to some embodiments, the first effluent is enriched in hydrocarbons having a carbon number of 3 to 18. According to some embodiments, the one or more light and/or medium hydrocarbon feeds comprise distillates. According to some embodiments, the one or more light and/or medium hydrocarbon feeds comprises one or more hydrocarbons having an average carbon number of 1 to 18. According to some embodiments, the one or more light and/or medium hydrocarbon feeds comprises one or more components selected from the group consisting of jet fuel, diesel, naphtha, kerosene, C4s, and oxygenates. According to some embodiments, the first FCC conditions comprise maintaining an outlet temperature of the first riser at 510° C. to 575° C. According to some embodiments, the first FCC conditions comprise mixing steam and the heavy hydrocarbon feed in the first riser a concentration of 1 wt. % to 6 wt %. According to some embodiments, the FCC conditions different than the first FCC conditions comprise maintaining an outlet temperature of the one or more risers different than the first riser at 550° C. to 675° C. According to some embodiments, the FCC conditions different than the first FCC conditions comprise mixing steam and the one or more light and/or medium hydrocarbon feeds at a concentration of 5 wt. % to 20 wt %. According to some embodiments, the reactor is configured to provide at least a portion of the first effluent to the one or more risers different than the first riser. According to some embodiments, providing at least a portion of the first effluent to the one or more risers different than the first riser comprises: using a fractionation system to fractionate the first effluent to yield a fractionated stream enriched in one or more of the components of the first effluent, and recycling the fractionated stream from the fractionation system to the one or more risers different than the first riser. According to some embodiments, the fractionated stream is enriched in one or more of naphtha and C4s. According to some embodiments, cracking one or more light and/or medium hydrocarbon feeds in one or more risers different than the first riser comprises: cracking a medium feed in a second riser under second FCC conditions, and cracking a light feed in a third riser under third FCC conditions different than the second FCC conditions. According to some embodiments, the medium feed comprises one or more of gasoline, kerosene, jet fuel, and diesel fuel. According to some embodiments, the second FCC conditions comprise maintaining an outlet temperature of the first riser at 550° C. to 675° C. According to some embodiments, the light feed comprises one or more of naphtha, C4s, and oxygenates. According to some embodiments, the FCC reactions in each of the risers comprise cracking using a catalyst mixture comprising a Y zeolite and a shape selective zeolite. According to some embodiments, the shape selective zeolite is ZSM-5.

### BRIEF DESCRIPTION OF THE DRAWINGS

FIG. 1 shows a multiple riser FCC reactor.

FIG. 2 shows a process using a multiple riser FCC reactor.

### DETAILED DESCRIPTION

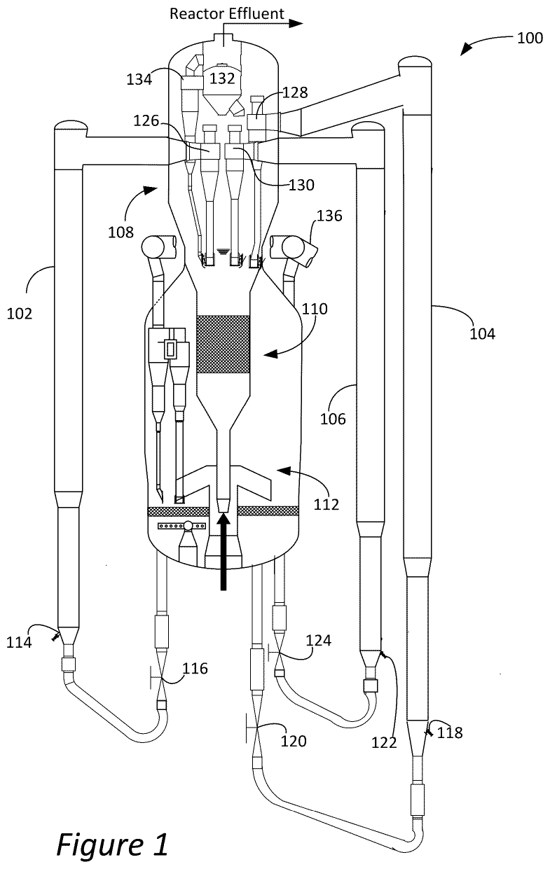

FIG. 1 illustrates one embodiment of a multiple-riser FCC reactor 100, as disclosed herein. The general functionality of FCC reactors are known in the art and is discussed here only briefly. Reactor 100 has three risers, 102, 104, and 106. However, other embodiments may have more or fewer risers, for example, two, four, five risers, etc. As described in more detail below, each of the risers may be configured for a different feedstock. Feedstock is provided to the first riser 102 at a first feed nozzle 114. According to some embodiments, any of the risers may comprise more than one nozzle. Catalyst is provided to the first riser at a first valve 116. The valve 116 may be a slide valve, for example. Feedstock is provided to the second riser 104 at a second feed nozzle 118 and catalyst is provided via a second valve 120. Feedstock is provided to the third riser 106 at a third feed nozzle 122 and catalyst is provided via a third valve 124. Each of the first, second, and third risers interface with dedicated cyclones 126, 128, and 130, respectively, which separate the bulk of the catalyst from each of the hydrocarbon riser effluents. The reactor comprises a plenum system 132 and one or more upper riser cyclones 134. While the illustrated embodiment has common upper cyclones, other embodiments may have dedicated 1^{st} and 2^{nd} stage cyclone systems for each riser. The plenum system 132 and one or more upper riser cyclones 134 are configured to remove remaining catalyst from the hydrocarbon product before the product exits the reactor as reactor effluent. According to some embodiments there may be separate lines instead of single reactor effluent line as shown in the drawing. The reactor comprises a disengages section 108, a stripper section 110, and a regenerator section 112. As is known in the art, spent catalyst that has been separated using the cyclones (e.g., 126, 128, 130, and 134) is provided to the stripper section 110, where hydrocarbons are stripped from the catalyst, for example, using steam. The stripped catalyst is then provided to the regenerator section 112, where the catalyst is heated to burn off coke. The hydrocarbon recovered from catalyst during stripping along with hydrocarbon separated through the cyclone comes out from reactor via exhaust 132 while the coke deposited on the catalyst is burnt off in regenerator section 112 and the produced flue gas due to burning of coke is escaped through exhaust 136. The regenerated catalyst can be recycled to the risers.

As mentioned above, the conditions of each of the risers may be tailored based on the feedstock reacted in that riser. The conditions that may be controlled within each riser include the temperature, the residence time of the feedstock within the riser, the partial pressure of the feedstock, and the ratio of catalyst to feedstock. The partial pressure of the feedstock is controlled by controlling the amount of steam injected into the riser. Generally, lighter reactants require more steam than heavier components for cracking and paraffinic feed requires more steam than olefinic feed.

Controlling the temperature within each riser is important because the cracking reaction is endothermic, meaning that heat must be supplied to the reactor process to heat the feedstock and maintain reaction temperature. The temperature required depends on the particular feedstock, and typically lighter molecules require higher temperature to sustain the reaction than do heavier molecules. The heat for sustaining the reaction in the risers is provided by heat produced during catalyst regeneration. During the conversion process with heavy feeds, coke is formed. The coke is deposited on the catalyst and ultimately burned with an oxygen source such as air in the regenerator section 112. Burning of the coke is an exothermic process that can supply the heat needed for the cracking reaction. The resulting heat of combustion from regeneration increases the temperature of the catalyst, and the hot catalyst is recirculated for contact with the feed in the riser, thereby maintaining the overall heat balance in the system. The amount of heat provided to a riser can be controlled by adjusting the amount of catalyst provided to the riser, for example, by controlling valves (e.g., valves 116, 120, and 124, FIG. 1). In balanced operation, no external heat source or fuel is needed to supplement the heat from coke combustion. Balanced operation may be obtainable if sufficient quantities of heavy materials are being processed, thereby forming sufficient quantities of coke to supply the heat needed for heat balance in all the risers. Oxygenates are normally exothermic so the heat can be balanced with right choice of feed even though coke production is less. Should additional heat be required to maintain heat balance, coke forming agents can be added to the feed to increase the amount of coke formed, and subsequently combusted. Alternatively, fuel can be added to the regeneration process. U.S. Pat. No. 8,383,052, the entire contents of which are hereby incorporated herein, describes how to maintain heat balance in an FCC reactor.

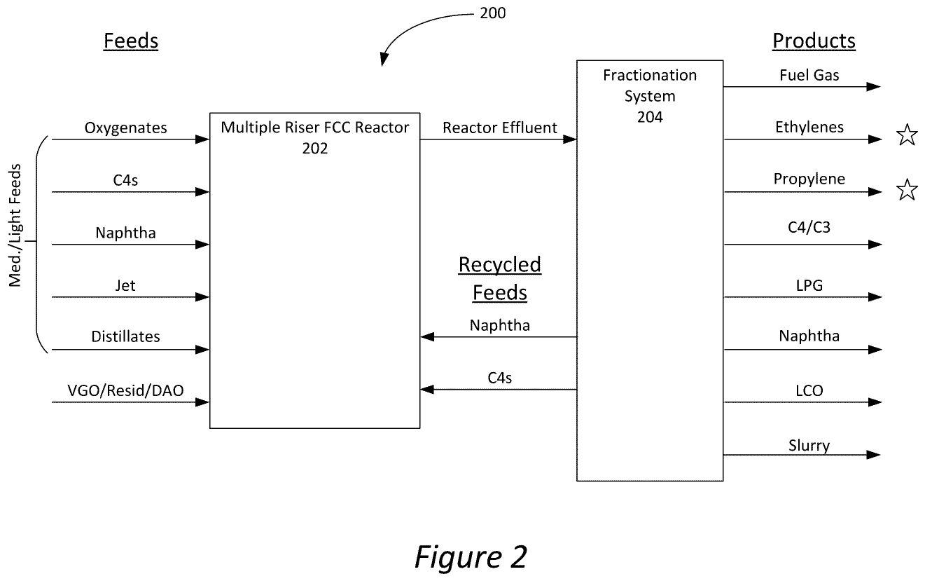

FIG. 2 illustrates an embodiment of a process 200 incorporating a multiple riser FCC reactor 202. The multiple riser FCC reactor 202 may be a three riser reactor, such as reactor 100 (FIG. 1) or may have more or few risers. FIG. 2 illustrates some examples of possible feed streams to the reactor 202. Note that the illustrated feeds are for example only and are not exhaustive. The reactor 202 will generally have at least one riser (referred to herein as the “heavy riser”) configured for heavy feeds, such as vacuum gas oil (VGO), reduced crudes, atmospheric tower bottoms, vacuum tower bottoms, resid, and/or de-asphalted oil (DAO). Generally, “heavy feed,” as used herein, refers to feed materials having an average carbon number greater than 18. According to some embodiments, the heavy riser may be configured to crack the heavy feeds into a stream that is enriched in fuel products (such as gasoline, diesel, heating oils, liquified petroleum gas, and the like) and/or naphtha.

The reactor 202 can also be configured with one or more risers configured to crack medium and/or light feeds into streams enriched with light olefins, such as ethylenes and/or propylenes. Generally, “medium feed” refers to feed materials having an average carbon number of about 8 to 18 and “light feed” refers to feed materials having an average carbon number of about 1 to 8. Examples of these medium and/or light feeds include paraffinic, cycloparaffinic, monoolefinic, diolefinic, cycloolefinic, naphthenic, and aromatic hydrocarbons, and hydrocarbon oxygenates. Further representative examples include light paraffinic naphtha; heavy paraffinic naphtha; light olefinic naphtha; heavy olefinic naphtha; mixed paraffinic C4s; mixed olefinic C4s (such as raffinates); mixed paraffinic C5s; mixed olefinic C5s (such as raffinates); mixed paraffinic and cycloparaffinic C6s; non-aromatic fractions from an aromatics extraction unit; oxygenate-containing products from a Fischer Tropsch unit; or the like; or any combination thereof. Hydrocarbon oxygenates can include alcohols having carbon numbers ranging of one to four, ethers having carbon numbers of two to eight and the like. Examples include methanol, ethanol, dimethyl ether, methyl tertiary butyl ether (MTBE), ethyl tertiary butyl ether, tertiary amyl methyl ether (TAME), tertiary amyl ethyl ether and the like

Distillates are an example of medium/light feed that may be cracked to yield light olefins in a riser of the reactor 202. As used herein, the term distillates may refer to one or more of naphtha, diesel, kerosene, and jet fuels. Distillates may be light distillates or middle distillates, as those terms are used in the art. According to some embodiments, the reactor 202 may have separate risers for different medium/light components. For example, the reactor may have a riser for diesel range material, another for jet fuel, and another for naphtha. According to some embodiments, feeds with very similar boiling points or characteristics may be provided to a common riser. Ideally, the reaction conditions in each riser can be optimized for converting its particular feedstock to light olefins. Also, the reactor 202 may comprise risers configured to handle feeds from different processes within the refinery. For example, an embodiment of a reactor 202 may have one riser configured to receive distillates from the crude distillation column, and those distillates may include straight run naphtha and/or straight run diesel as a component. The reactor may also have another riser that can receive naphtha from other processes, such as from a coker and/or from a visbreaker.

As illustrated in FIG. 1, the hydrocarbon products from each of the risers typically leave the reactor as a single, combined reactor effluent. Accordingly, the reactor effluent comprises effluents from each of the risers, including the stream(s) enriched in fuel/naphtha products from the heavy riser and the stream(s) enriched in lighter products (e.g., light olefins) obtained from the one or more light/medium feed risers. Alternatively, each riser may have a dedicated effluent line. Referring again to FIG. 2, the reactor effluent may be provided to a fractionation system 204. The fractionation system will not be described in detail here, as fractionation is generally well known in the art and the particular configuration will depend on the circumstances. Generally, the fractionation system may comprise one or more distillation columns configured to separate the reactor effluent into its components to yield a spectrum of products, as illustrated. Embodiments of the process 200 are configured to shift the product spectrum to heavier quantities of light olefins, such as ethylenes and/or propylenes. According to some embodiments, one or more streams from the fractionation system 204 may be recycled back to the FCC reactor 202. For example, a stream enriched in naphtha and/or C4+ species may be recycled as feed to one of the risers of the reactor 202. Thus, some embodiments of the process 200 may involve cracking a heavy stream in a heavy riser to produce a first effluent stream enriched in lighter components such as fuel products, C4s, and/or naphtha, providing the first effluent stream to a fractionation system and fractionating the first effluent stream to produce one or more second streams, and recycling the one or more second streams back to one or more light/medium risers of the FCC reactor, where they are further cracked to yield light olefins.

Conventional FCC processes configured to produce gasoline, etc., typically use Y-zeolite catalysts, which are configured to crack larger (C9+) molecules. Other examples of catalysts useful in fluidized catalytic cracking include USY, REY, RE-USY, faujasite and other synthetic and naturally occurring zeolites and mixtures thereof. Embodiments of the disclosed dual riser processes described herein may use such catalysts combined with catalysts that are better configured for cracking light feeds to produce light olefins. Examples of light feed catalysts include shape-selective zeolites configured to crack naphtha-range molecules. Examples of suitable catalysts for use in the cracking of light feeds are exemplified by ZSM-5 and similar catalysts. Other catalysts include ZSM-11, ZSM-12, ZSM-23, ZSM-35, ZSM-38, and ZSM-48. The proportion of Y-Zeolite catalyst and shape-selective zeolites are optimized based on the feedstock involved and product targets.

As an example of how a multi-riser FCC reactor can be used in a process for providing light olefins, consider the reactor 100 (FIG. 1). Assume that riser 102 is the heavy riser (i.e., the riser configured for cracking heavy feed). The conditions in riser 102 may be optimized to crack the heavy feed to yield an effluent enriched in medium range products, such as naphtha or fuel products. Assume that riser 104 is configured to crack medium range feed and riser 106 is configured to crack light feed, each to yield effluents enriched in light olefins. In this example, assume that the heavy feed is VGO, the medium feed is straight run diesel, and the light feed is light naphtha recycle. Table 1 below lists example ranges for the temperature, residence time, partial pressure control (i.e., amount of steam), and the catalyst/oil ratio for each of the risers. As explained herein, each riser can be individually tailored for its particular feed. Notice that the lightest component, light naphtha (riser 106) has the highest temperature and the highest amount of steam; the medium weight feed, diesel (riser 104), has medium temperature and medium steam; and the heaviest feed, VGO (riser 102), has the lowest temperature and the least steam.

TABLE 1
Operating Conditions of Exemplary Three Riser FCC.

| Parameter | Riser 102 | Riser 104 | Riser 106 |
|---|---|---|---|
| Feed | VGO | SR Diesel | Light Naphtha |
| Outlet Temp. (° C.) | 510-575 | 550-675 | 585-675 |
| Residence Time (sec) | 1.5-2.5 | 1.5-2.5 | 1.7-3.5 |
| Steam wt % | 1.0-6.0 | 5.0-10 | 10-20 |
| Catalyst/Oil ratio wt % | 6-12 | 9-20 | 15-30 |

Although particular embodiments of the present invention have been shown and described, it should be understood that the above discussion is not intended to limit the present invention to these embodiments. It will be obvious to those skilled in the art that various changes and modifications may be made without departing from the spirit and scope of the present invention. Thus, the present invention is intended to cover alternatives, modifications, and equivalents that may fall within the spirit and scope of the present invention as defined by the claims.

What is claimed is:

1. A process for cracking hydrocarbons using a multiple riser fluid catalytic cracking (FCC) reactor, the method comprising:
cracking a heavy hydrocarbon feed in a first riser using first FCC conditions to form a first effluent enriched in medium and/or light hydrocarbons, and
cracking one or more light and/or medium hydrocarbon feeds in one or more risers different than the first riser under FCC conditions different than the first FCC conditions to form one or more effluents enriched in light olefins.

2. The process of claim 1, wherein the heavy feed comprises one or more hydrocarbons having an average carbon number of 18 or more.

3. The process of claim 1, wherein the heavy feed comprises one or more components selected from the group consisting of vacuum gas oil (VGO), reduced crudes, atmospheric tower bottoms, vacuum tower bottoms, resid, and de-asphalted oil (DAO).

4. The process of claim 1, wherein the first effluent is enriched in hydrocarbons having a carbon number of 3 to 18.

5. The process of claim 1, wherein the one or more light and/or medium hydrocarbon feeds comprise distillates.

6. The process of claim 1, wherein the one or more light and/or medium hydrocarbon feeds comprises one or more hydrocarbons having an average carbon number of 1 to 18.

7. The process of claim 1, wherein the one or more light and/or medium hydrocarbon feeds comprises one or more components selected from the group consisting of jet fuel, diesel, naphtha, kerosene, C4s, and oxygenates.

8. The process of claim 1, wherein the first FCC conditions comprise maintaining an outlet temperature of the first riser at 510° C. to 575° C.

9. The process of claim 1, wherein the first FCC conditions comprise mixing steam and the heavy hydrocarbon feed in the first riser a concentration of 1 wt. % to 6 wt %.

10. The process of claim 1, wherein the FCC conditions different than the first FCC conditions comprise maintaining an outlet temperature of the one or more risers different than the first riser at 550° C. to 675° C.

11. The process of claim 1, wherein the FCC conditions different than the first FCC conditions comprise mixing steam with the one or more light and/or medium hydrocarbon feeds at a concentration of 5 wt. % to 20 wt %.

12. The process of claim 1, further comprising providing at least a portion of the first effluent to the one or more risers different than the first riser.

13. The process of claim 12, wherein providing at least a portion of the first effluent to the one or more risers different than the first riser comprises:
using a fractionation system to fractionate the first effluent to yield a fractionated stream enriched in one or more of the components of the first effluent, and
recycling the fractionated stream from the fractionation system to the one or more risers different than the first riser.

14. The process of claim 13, wherein the fractionated stream is enriched in one or more of naphtha and C4s.

15. The process of claim 1, wherein cracking one or more light and/or medium hydrocarbon feeds in one or more risers different than the first riser comprises:
cracking a medium feed in a second riser under second FCC conditions, and
cracking a light feed in a third riser under third FCC conditions different than the second FCC conditions.

16. The process of claim 15, wherein the medium feed comprises one or more of gasoline, kerosene, jet fuel, and diesel fuel.

17. The process of claim 15, wherein the second FCC conditions comprise maintaining an outlet temperature of the first riser at 550° C. to 675° C.

18. The process of claim 15, wherein the light feed comprises one or more of naphtha, C4s, and oxygenates.

19. The process of claim 1, wherein the FCC reactions in each of the risers comprise cracking using a catalyst mixture comprising a Y zeolite and a shape selective zeolite.

20. The process of claim 19, wherein the shape selective zeolite is ZSM-5.
